(19) United States
(12) Patent Application Publication
(10) Pub. No.: US 2026/0302887 A1
(43) Pub. Date: Oct. 1, 2026

(54) HYDRO PNEUMATIC SHOCK AND TURBULENCE ENERGY GENERATOR

(71) Applicant: Ashraf Hossain, Norwich, CT (US)

(72) Inventor: Ashraf Hossain, Norwich, CT (US)

(21) Appl. No.: 19/632,489

(22) Filed: Mar. 30, 2026

Related U.S. Application Data
(60) Provisional application No. 63/780,362, filed on Mar. 30, 2025.

(51) Int. Cl. H02K 7/18; B60G 13/14; B64D 41/00

(52) U.S. Cl. CPC H02K 7/1853; B60G 13/14; B64D 41/00; B60G 2202/24; B60G 2206/41; B60G 2800/162

(57) ABSTRACT

A system, method, and apparatus are provided for recovering energy from shock and turbulence encountered by a vehicle and charging a battery to store such energy. An apparatus is provided, comprising: a first piston activated by a force from a vehicle movement, such as shock collisions or turbulence; a second piston fluidically coupled to first piston; and an alternator shaft connected to a rechargeable battery. In the apparatus, the first piston has a first surface area, and the second piston as a second surface area. The second piston comprises a surface that collides with the alternator shaft to cause the alternator to turn and charge the battery when the second piston is actuated.

### CROSS-REFERENCE TO RELATED APPLICATIONS

The present application claims the benefit of U.S. Provisional Application No. 63/780,362 filed Mar. 30, 2025, which is hereby incorporated by reference in its entirety.

### BACKGROUND OF THE APPLICATION

The present application relates to a device, system and method to restore energy from ground vehicle shock and air vessel turbulence.

### SUMMARY OF THE APPLICATION

The present application relates to an apparatus for recovering energy from shock and turbulence encountered by a vehicle and charging a battery to store such energy.

An apparatus is provided, comprising: a first piston activated by a force from a vehicle movement, such as shock collisions or turbulence; a second piston fluidically coupled to first piston; and an alternator shaft connected to a rechargeable battery. In the apparatus, the first piston has a first surface area, and the second piston as a second surface area preferably larger than the first surface area. The second piston comprises a surface that collides with the alternator shaft to cause the alternator to turn and charge the battery when the second piston is actuated.

The first piston can be arranged in a vehicle, such as an automobile, within a shock absorber so that ground reaction force affecting the shock absorber causes the actuation of the first piston. The first piston could also be arranged in a vehicle subject to turbulence, such as an aircraft, where turbulence causes the actuation of the first piston. The first piston could also comprise a series or plurality of pistons.

The fluid connection between the first piston and the second piston may comprise a hydraulic fluid, and actuating the first piston causes the second piston to also be actuated by the hydraulic fluid movement.

### BRIEF DESCRIPTION OF THE FIGURES

FIG. 1 shows an example of an automobile comprising pistons mounted to shock absorbers according to the present application;

FIG. 2 shows an example of piston compression according to the present application;

FIG. 3 shows an amplification of a ground force reaction with a piston rod according to the present application;

FIG. 4 shows the mounting of pistons between the frame and compartment of an air vessel according to the present application;

FIG. 5 shows compression of pistons positioned between the frame and compartment of an air vessel according to the present application;

FIG. 6 shows a piston rod can collide with an alternator shaft upon compression of the piston between the frame and compartment;

FIG. 7 shows a diagram illustrating Pascal's Principle;

FIG. 8 shows a diagram of pistons of different cross-sectional areas being used;

FIG. 9 shows an example of an elastic collision;

FIG. 10 shows an example of the forces of a floating object;

FIGS. 11A and 11B show diagrams of the volume of fluid displaced by opposing pistons; and

FIG. 12 shows a diagram of the mass of an output piston rod and an alternator shaft.

### DETAILED DESCRIPTION OF THE FIGURES

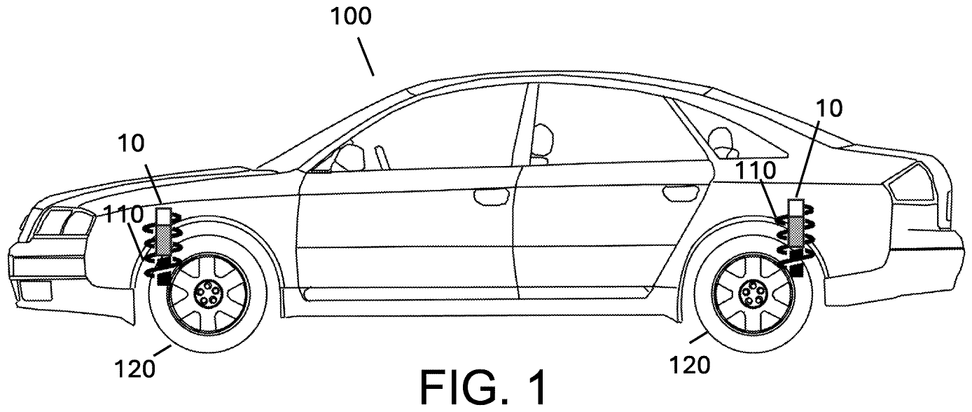

The subject matter of the present application will now be described with reference to FIGS. 1-12.

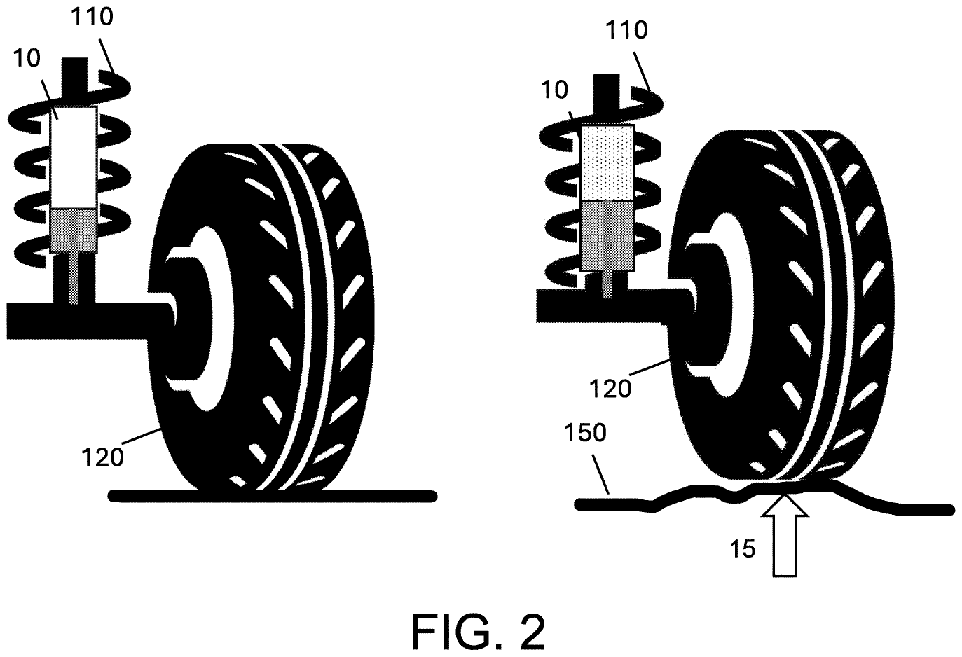

As a ground vehicle 100 drives over terrain 150, the shock absorber 110 is constantly working to dissipate shock. The vehicle 100 is constantly translating up and down with respect to the wheels 120 of the vehicle 100. Pistons 10 can be mounted to a ground vehicle shock absorber 110 to displace and compress air or hydraulic fluid to restore energy back into the system in addition to dampening the effects of uneven terrain. FIG. 1 shows an example of an automobile 100 comprising pistons 10 mounted to shock absorbers 110. If a piston 10 is placed within the shock absorber 110, the piston 10 can be compressed during this up and down motion 15 of the body of the vehicle 100, as shown for example in FIG. 2. A description of tire deformation in a vehicle being used to power a piston can be found in Applicant's previously filed U.S. application Ser. No. 19/367,751for a “Hydro Pneumatic Energy Wheel” on Oct. 23, 2025, which is hereby incorporated by reference in its entirety.

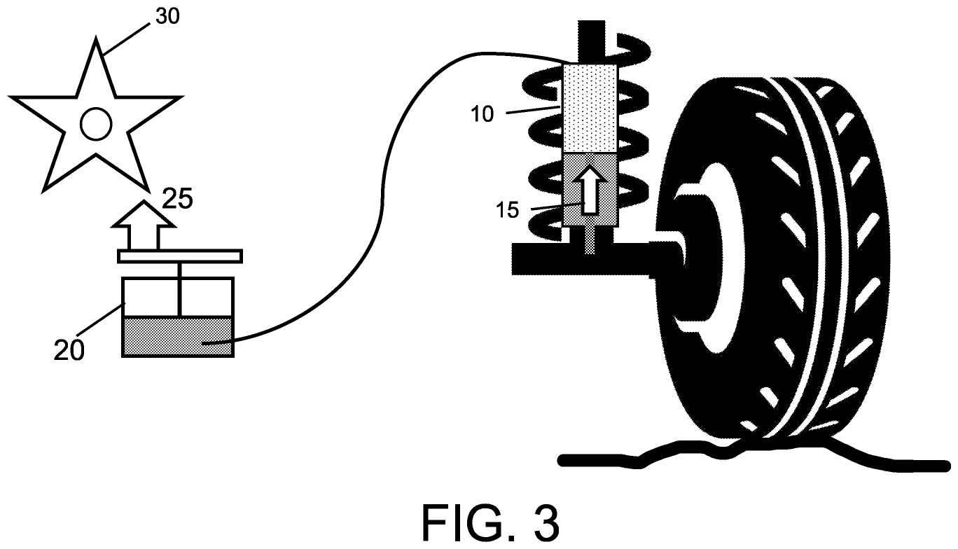

In accordance with the present application, as shown in FIG. 3, a separate and second piston 20 is provided. The second piston 20 comprises a surface attached to the piston rod, which may have a larger surface area than a corresponding surface on the piston 10 within the shock absorber 110. The second piston 20 is fluidly connected to the first piston 10, such that compression of the first piston 10 translates to the second piston 20. The second piston 20, when actuated, collides 25 with an alternator 30 connected to a battery to turn the alternator 30.

When the piston 10 placed between the shock absorber 110 compresses, the ground reaction force 15 will be amplified at the piston rod 20. The piston rod 20 can collide 25 with the alternator shaft 30 and cause the alternator shaft 25 to free spin resulting in battery charging. An example of this is shown in FIG. 3. As a result, a massive amount of energy can be restored back into the battery.

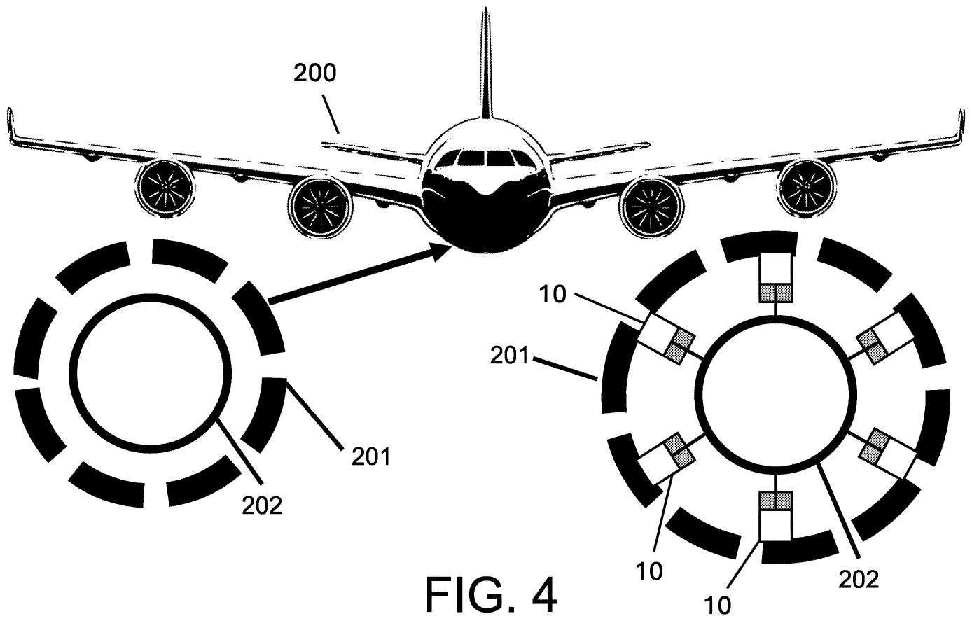

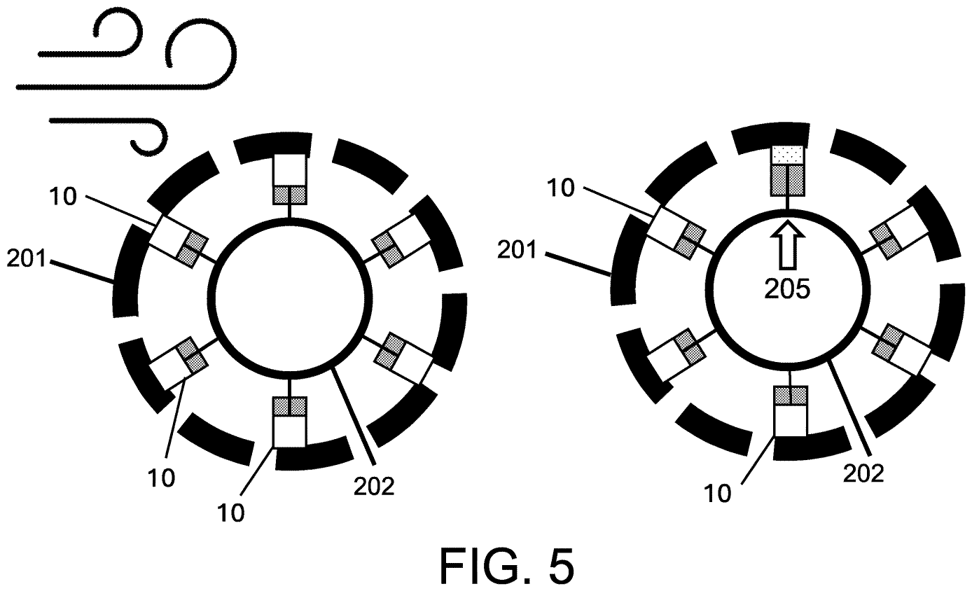

A further example of this can be seen from turbulence energy. Using an air vessel, like an airplane 200, as an example, the fuselage of an air vessel can be broken down into two sections, the frame 201 and the compartment 202. Pistons 10 can be mounted between the frame 201 and compartment 202 to displace and compress air or hydraulic fluid to restore energy back into the system in addition to dampening the effects of turbulence, as shown in FIG. 4. If turbulence 205 pushes the compartment 202 upwards with respect to the frame 201 of the fuselage, pistons 10 can be compressed, and conversely, pistons 10 can be compressed to capture fuselage reaction force at other directions during turbulence with strategic placement of pistons 10. This is shown in FIG. 5, for example.

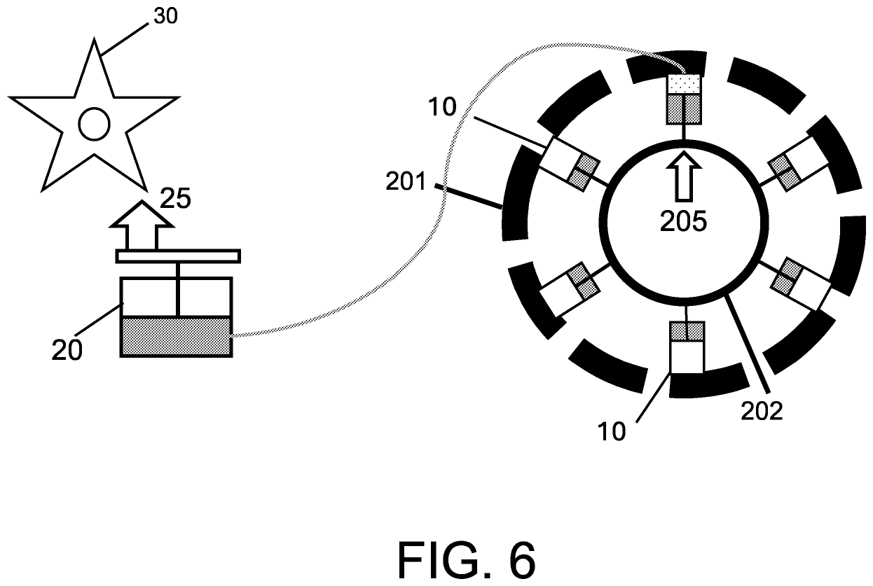

As shown in FIG. 6, when the piston 10 compresses, the fuselage reaction force will be amplified at the larger piston rod 20. The piston rod 20 can collide with an alternator shaft 30 and cause the alternator shaft 30 to free spin resulting in battery charging. This system restores a massive amount of energy back into the battery.

Various scientific principles are employed by the system described above.

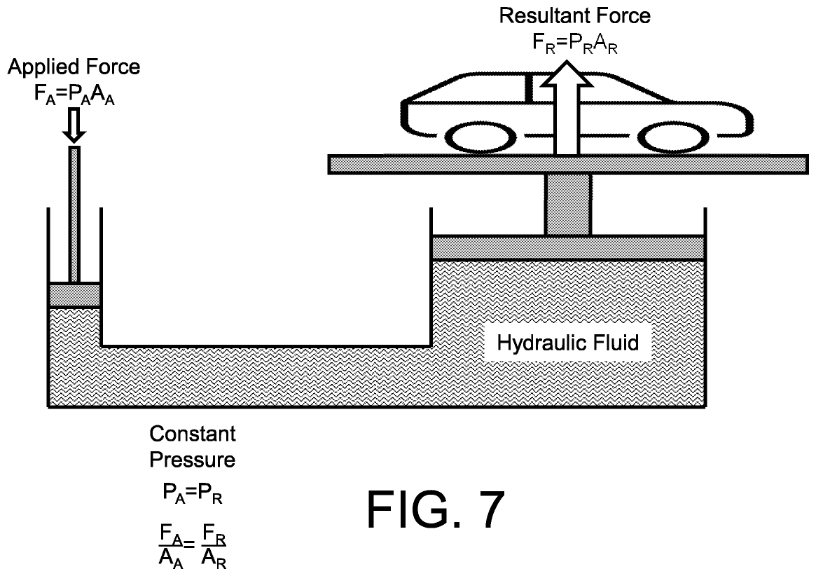

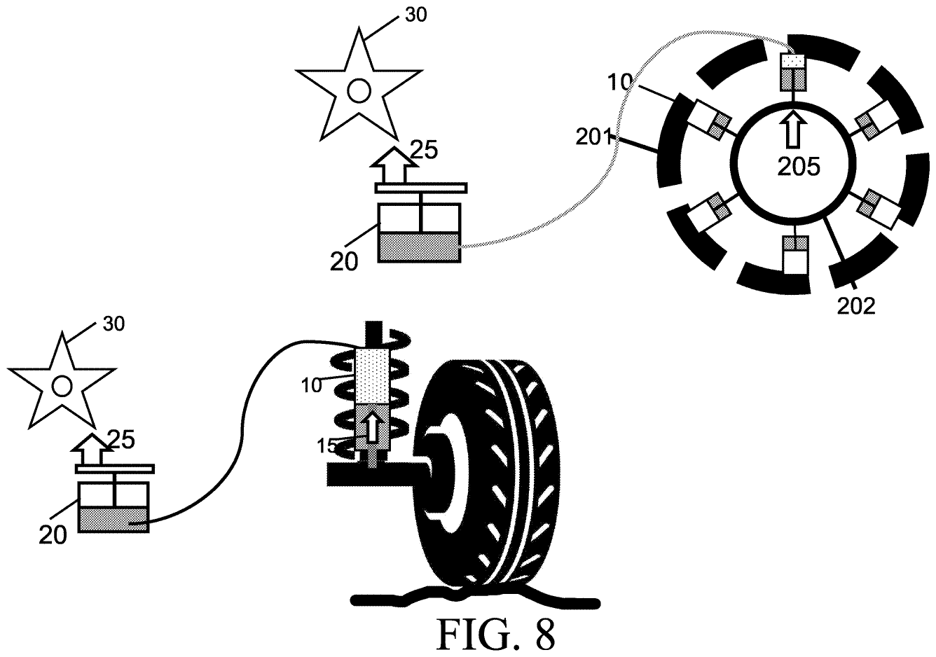

First, in accordance with Pascal's principle, pressure within an enclosed body of incompressible fluid remains constant. In a system with a smaller piston and a larger piston, as shown for example in FIG. 7, if a force is applied to push a small piston (left side), the reaction force applied at the larger piston (right-side) amplifies with respect to the cross-sectional area of the piston. There is a relationship between the force and cross-sectional area. Pistons can therefore be sized to amplify the force applied at the smaller piston to spin an alternator shaft upon impact with the larger piston rod, as shown in FIG. 8 for example.

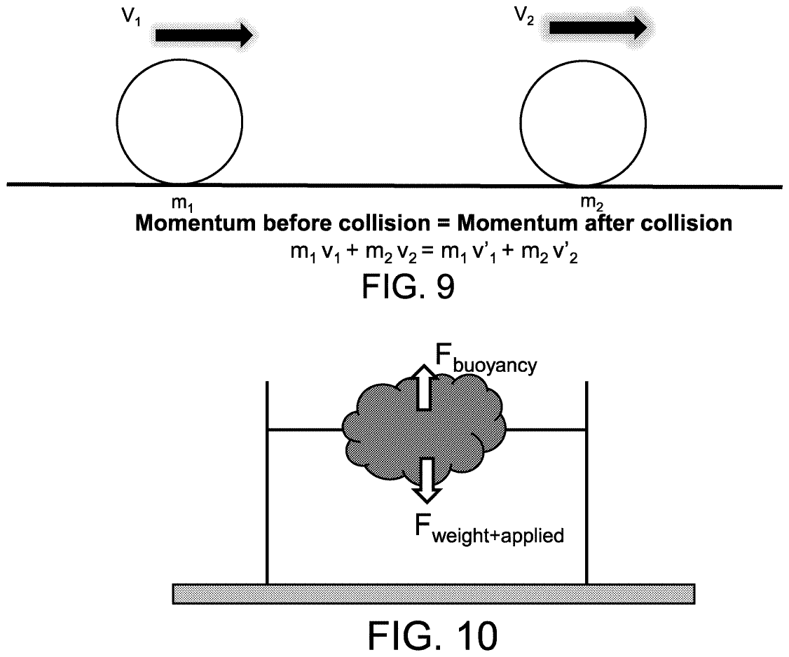

The conservation of momentum also applies. FIG. 9 shows an elastic collision. The bodies separate following collision, and energy is transferred from one body to the other upon collision. If initial conditions are known, the velocities of the two bodies can be determined. Further, in accordance with Archimedes'Principle, an object placed on a body of water is subject to buoyancy force that keeps the object afloat. A floating object does not induce a reaction force on a bottom platform supporting the body of water, shown for instance in FIG. 10.

Upon combination of Pascal's Law, Conservation of Momentum, and Archimedes Principle, the reaction force as a result of impact with the alternator will not induce much of a resistance from the perspective of the smaller piston. The reaction force will dissipate into the fluid and the body of the two vehicles where the larger piston is mounted, as shown in FIG. 10.

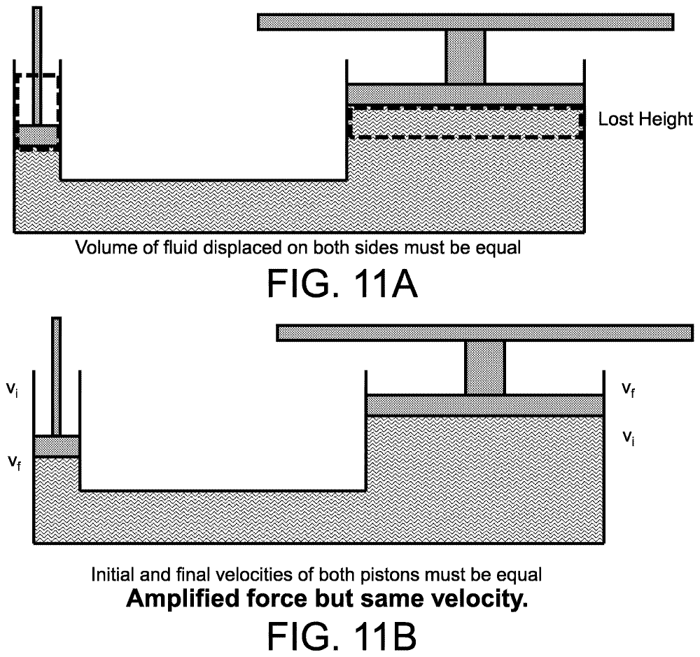

There is a loss however, which is shown in FIG. 11A. For incompressible fluid, the volume of fluid displaced on both sides must be equal. This implies that the piston on the larger side will rise by a smaller height compared to the smaller piston, and there is smaller piston movement on the output side But for incompressible fluid, the initial and final velocities (vᵢ and v_{f}, respectively) of the pistons are conserved, so if the final velocity of the smaller piston is x, the velocity of the output piston rod will also be x during impact, and so the force will be greater (FIG. 11B).

Thus, the output shaft with amplified force collides with the alternator shaft, and the alternator spins without restricting the movement to the output shaft displacement, and this is repeated at every iteration with respect to the smaller piston position.

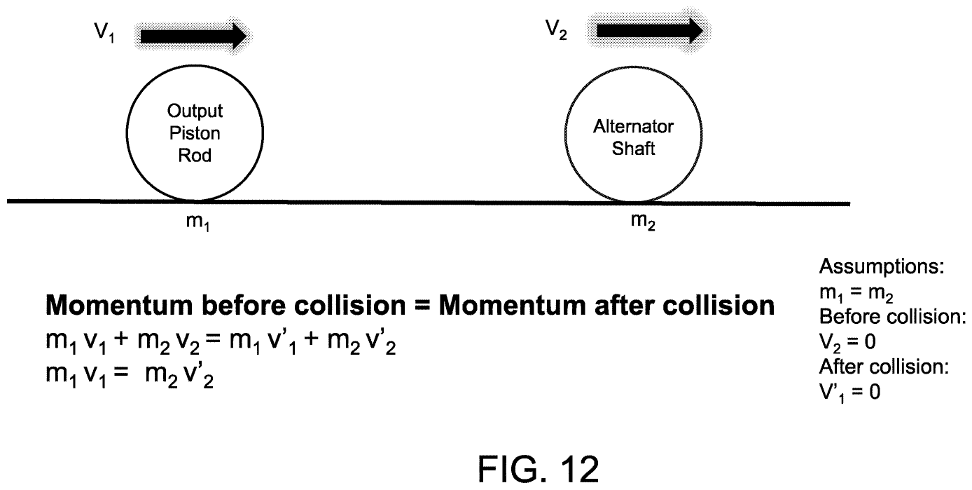

For the first iteration, assuming that the mass of the output piston rod and the mass of the alternator shaft is equal, the alternator shaft can be spun with the same velocity of the input piston upon impact (FIG. 12). Connecting the alternator to the battery will result in battery charging. The only resistive force that the power supply will witness is the weight of the additional components.

The resistive force is much smaller compared to the impact force. The power required to compress the piston is much smaller compared to the power produced by the alternator. Thus, a massive amount of energy can be recovered back into the battery using the hydro pneumatic shock and turbulence energy generator described herein.

As used herein, directional or positional terms such as “front”, “rear”, “upper”, “lower”, “top”, “bottom”, etc., are used for explanatory purposes only to describe the system as illustrated in the figures.

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed:

1. An apparatus comprising:
a first piston activated by a force from a vehicle movement;
a second piston fluidically coupled to first piston; and
an alternator shaft connected to a rechargeable battery.

2. The apparatus of claim 1, wherein the first piston has a first surface area, and the second piston has a second surface area.

3. The apparatus of claim 2, wherein the second piston comprises a surface that collides with the alternator shaft to cause the alternator to turn and charge the battery when the second piston is actuated.

4. The apparatus of claim 3, wherein the first piston is arranged in an automobile, within a shock absorber so that ground reaction force affecting the shock absorber causes the actuation of the first piston.

5. The apparatus of claim 3, wherein the first piston is arranged in an aircraft, wherein turbulence causes the actuation of the first piston.

6. The apparatus of claim 3, wherein the first piston comprises a plurality of pistons.

7. The apparatus of claim 1, wherein the first piston has a first surface area, and the second piston has a second surface area larger than the first surface area.
